(19) United States
(12) Patent Application Publication
(10) Pub. No.: US 2023/0244761 A1
(43) Pub. Date: Aug. 3, 2023

(54) TECHNIQUES FOR PROVIDING COMPUTER-MEDIATED REALITY CONTENT AS DIGITAL MULTIMEDIA EXPERIENCES VIA WEBPAGE NON-FUNGIBLE TOKENS

(71) Applicant: Concept Source, Inc., Plainview, NY (US)

(72) Inventors: Charles RAFFAY, Jensen Beach, FL (US); Darlene FALLAS, Long Island, NY (US); Robert FALLAS, Huntington, NY (US); Alex RAFFAY, Jensen Beach, FL (US)

(73) Assignee: Concept Source, Inc., Plainview, NY (US)

(21) Appl. No.: 17/649,604

(22) Filed: Feb. 1, 2022

(51) Int. Cl. G06F 21/10; G06T 19/00; G06F 21/60

(52) U.S. Cl. CPC G06F 21/10; G06F 21/602; G06T 19/006; G06F 2221/0704

(57) ABSTRACT

Techniques for encoding tokenizing digital multimedia experiences and, in particular, computer-mediated reality experiences. A method includes encoding a webpage into portions of code. The webpage is associated with a unique digital asset representing a digital multimedia experience (DME). Each portion of code causes projection of computer-mediated reality media content corresponding to the unique asset, thereby altering a perception of a reality. The method further includes creating a database including nodes. The nodes include webpage nodes connected to non-fungible token (NFT) nodes. The portions of code of the webpage are stored among the nodes. The method also includes providing the portion of code to a device authorized by an owner of one of the NFT node based on the connections in the database.

### TECHNICAL FIELD

The present disclosure relates generally to web-based non-fungible tokens (NFTs), and more specifically to providing computer-mediated reality content such as augmented reality (AR) content as digital multimedia experiences (DMEs) via web-based NFTs.

### BACKGROUND

A non-fungible token (NFT) is a non-interchangeable unit of data associated with an asset such as a physical or digital item. Because NFTs are unique, they can be utilized to provide data scarcity even for data that is easily replicated. Thus, owning an NFT can provide the ability to own data uniquely (i.e., such that only a single person or entity owns that data) or semi-uniquely (such as when a limited group of people each own a copy of the data). NFTs typically cannot be copied or transferred without permission, and can serve as a proof of authenticity as well as a means for accessing the owned assets.

Existing solutions for providing NFTs record transactions involving transfers of NFTs to a blockchain. A blockchain is a distributed digital ledger storing transaction data, where the distributed ledger is stored on multiple nodes such that each node is a computer storing a copy of the blockchain. Because copies of the blockchain are stored across multiple nodes, records cannot be altered on one node in order to falsify the records among the nodes. When new transaction data is to be added to the blockchain, the nodes validate the new transaction data and reach consensus regarding what data should be included in the updated blockchain. When such consensus occurs, transaction data is recorded on the blockchain on each node.

According to existing solutions, when an NFT is transferred, the ability to access the NFT may be provided via a wallet storing data about the NFT that was transferred as recorded on the blockchain. The wallet is a device or program storing the ownership data and including code for managing and transferring ownership of digital assets such as NFTs and cryptocurrencies.

Due to the properties of NFTs allowing for uniquely assigning data ownership to users, NFTs can be utilized to provide and manage access to content in new ways. One such kind of content which could be owned via NFTs is computer-mediated reality content such as augmented reality (AR), virtual reality (VR), or mixed reality (MR) content. Computer-mediated reality content is used to add to, subtract information from, modify, or otherwise alter the perception of reality through the use of a computing device such as a wearable computer or handheld device (e.g., a smartphone). Many computer-mediated reality techniques involve altering visual media content presented to a user in order to cause the real-world environment to appear differently in the altered visual media content than it does in the original visual media content, although computer-mediated reality techniques may be equally applied to other forms of content such as audio.

Augmented reality content enhances video or other content showing a real-world environment with a portion of virtual world content, and may be realized, for example, as an overlay of virtual-world content over video of real-world content. Virtual reality content provides a simulated experience that replaces a user’s perception of a real-world environment with virtual world content. Mixed reality content is merged with content showing a real-world environment in a mixed environment where physical and digital objects co-exist and may interact in real-time.

With the rapid adoption of computer-mediated reality technologies, techniques for providing such experiences to users have become increasingly desirable. Further, new techniques that allow for tokenizing and owning computer-mediated reality content would be desirable to provide users with such content in new ways.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for encoding assets owned via tokens as webpages. The method comprises: encoding a webpage into at least one portion of code, wherein the webpage is associated with at least one unique digital asset representing at least one computer-mediated reality experience, wherein each portion of code causes projection of computer-mediated reality media content corresponding to the at least one unique asset by a system when the portion of code is executed by the system, wherein the projected computer-mediated reality media content at least partially alters a perception of a reality reflected in sensor signals captured by at least one sensor of the system; creating a database including a plurality of nodes, the plurality of nodes including a plurality of webpage nodes and a plurality of non-fungible token (NFT) nodes, wherein the encoded at least one portion of code of the webpage is stored among a portion of the plurality of nodes, wherein a first webpage node of the plurality of webpage nodes is associated with the webpage, wherein at least one first NFT node of the plurality of NFT nodes is connected to the first webpage node, wherein each of the at least one first NFT node corresponds to one of the at least one unique digital asset; and providing the at least one portion of code to a device authorized by an owner of the at least one first NFT node.

Certain embodiments disclosed herein also include a non-transitory computer readable medium having stored thereon causing a processing circuitry to execute a process, the process comprising: encoding a webpage into at least one portion of code, wherein the webpage is associated with at least one unique digital asset representing at least one computer-mediated reality experience, wherein each portion of code causes projection of computer-mediated reality media content corresponding to the at least one unique asset by a system when the portion of code is executed by the system, wherein the projected computer-mediated reality media content at least partially alters a perception of a reality reflected in sensor signals captured by at least one sensor of the system; creating a database including a plurality of nodes, the plurality of nodes including a plurality of webpage nodes and a plurality of non-fungible token (NFT) nodes, wherein the encoded at least one portion of code of the webpage is stored among a portion of the plurality of nodes, wherein a first webpage node of the plurality of webpage nodes is associated with the webpage, wherein at least one first NFT node of the plurality of NFT nodes is connected to the first webpage node, wherein each of the at least one first NFT node corresponds to one of the at least one unique digital asset; and providing the at least one portion of code to a device authorized by an owner of the at least one first NFT node.

Certain embodiments disclosed herein also include a system for encoding assets owned via tokens as webpages. The system comprises: a processing circuitry; and a memory, the memory containing instructions that, when executed by the processing circuitry, configure the system to: encode a webpage into at least one portion of code, wherein the webpage is associated with at least one unique digital asset representing at least one computer-mediated reality experience, wherein each portion of code causes projection of computer-mediated reality media content corresponding to the at least one unique asset by a system when the portion of code is executed by the system, wherein the projected computer-mediated reality media content at least partially alters a perception of a reality reflected in sensor signals captured by at least one sensor of the system; create a database including a plurality of nodes, the plurality of nodes including a plurality of webpage nodes and a plurality of non-fungible token (NFT) nodes, wherein the encoded at least one portion of code of the webpage is stored among a portion of the plurality of nodes, wherein a first webpage node of the plurality of webpage nodes is associated with the webpage, wherein at least one first NFT node of the plurality of NFT nodes is connected to the first webpage node, wherein each of the at least one first NFT node corresponds to one of the at least one unique digital asset; and provide the at least one portion of code to a device authorized by an owner of the at least one first NFT node.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2A is a visual depiction of nodes in a database realized as a hypergraph.

FIG. 2B is a visual depiction of nodes in a database including a token series node.

FIG. 3 is a flowchart illustrating a method for providing computer-mediated reality content via webpage NFTs according to an embodiment.

FIG. 4 is a flowchart illustrating a method for creating an NFT database according to an embodiment.

FIG. 5 is a flowchart illustrating a method for transferring NFT nodes of webpages using a database according to an embodiment.

FIG. 6 is a schematic diagram of a NFT provider according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include methods and systems for providing computer-mediated reality content as digital multimedia experiences (DMEs) via webpage non-fungible tokens (NFTs). The disclosed embodiments can be utilized to tokenize computer-mediated reality content such as augmented reality (AR), virtual reality (VR), or mixed reality (MR) media content included in webpages. More specifically, various disclosed embodiments involve encoding a webpage into one or more portions of code that include instructions for projecting the media content of the webpage via one or more computer-mediated reality techniques (e.g., by projecting the media content on top of video from a camera as an AR experience or by replacing video footage with media content as a VR experience), and tokenizing the encoded webpage by creating nodes representing the webpage as well as nodes representing NFTs indicating ownership of the computer-mediated reality content associated with the webpage.

In an embodiment, a request to mint a computer-mediated reality experience as an NFT is received. The computer-mediated reality experience is realized via a webpage including computer-mediated reality content and software instructions for providing a computer-mediated reality experience using the computer-mediated reality content. The webpage is encoded into one or more portions of code including code for using content of the webpage to provide a computer-mediated reality experience. A database is created or updated such that the database includes one or more webpage nodes representing the webpage and one or more NFT nodes representing NFTs that indicate ownership of respective computer-mediated reality experiences of the webpage. The portions of the encoded webpage are distributed among nodes in the database. The webpage (or a portion thereof) may represent a digital asset in the form of a digital multimedia experience (DME) such as an AR or VR experience, and may include media content used to provide the AR or VR experience, models or other data used to create media content for providing such an experience, both, and the like.

Once the database including the webpage nodes and the NFT nodes is created or updated, the database may optionally be stored on a decentralized ledger such as a blockchain. Further, at any point after the database is created or updated, the NFT nodes may be transferred (thereby transferring the NFTs represented by the NFT nodes) by altering connections between nodes in the database, thereby further updating the database.

When a user associated with a given NFT node (e.g., a user of a wallet represented by a wallet node connected to the NFT node in the database) desires to access the computer-mediated reality experience represented by the NFT node, the user may request that such an experience be provided. This request may require some form of authentication, for example, via a wallet device or application associated with the NFT node. The content and instructions for providing the requested experience are provided to a device authorized by the user such as, but not limited to, a user device operated by the user. Specifically, the respective portions of code of the encoded webpage are provided to the user device such that they can be executed by the user device, thereby configuring the user device to provide a computer-mediated reality experience in accordance with the encoded instructions of the webpage.

In an embodiment, when these portions of code are executed on the user device, the user device becomes configured at least to access one or more sensors of the user device and to project media content through one or more output devices of the user device (e.g., a screen, a speaker, both, etc.) in order to alter a user’s perception of the real-world as reflected in media content created using data from sensors of the user device, thereby providing a computer-mediated reality experience to the user of the user device. To this end, the portions of code, when executed, may further configure the user device to perform actions such as, but not limited to, access output devices of the user device (e.g., a screen, speaker, etc.), generate media content based on three-dimensional models, determine applicable content for a given location and orientation, combinations thereof, and the like.

The disclosed embodiments utilize encoded portions of web-based content tokenized as nodes in a database in order to effectively enable providing computer-mediated reality experiences as NFTs or other non-interchangeable tokens. More specifically, the disclosed embodiments provide techniques which manipulate interactions with the Internet in order to tokenize computer-mediated reality experiences as NFTs, namely, by encoding webpages containing content and instructions to be used for providing computer-mediated reality experiences, distributing the encoding webpages among the database, and connecting webpage nodes representing the encoded webpages to respective NFT nodes representing ownership of a webpage or portion thereof as an NFT. Accordingly, the various disclosed embodiments effectively allow for using NFTs as tickets to access computer-mediated reality experiences.

The disclosed embodiments further provide techniques for utilizing various nodes in order to allow for modular enforcement of various policies related to creation of tokens, use of tokens, access to tokens, and the like. These various nodes therefore allow for enforcing policies and controlling access to computer-mediated reality experiences owned via NFTs.

Additionally, various disclosed embodiments allow for providing additional functionality for digital tokens such as NFTs or otherwise include new techniques for providing such functionality. Such additional functionality may include, but is not limited to, allowing for multi-ownership wallets in which multiple entities are assigned ownership of a single jointly owned wallet, tokenizing discrete sections of the same webpage, aggregating content from multiple webpages of commonly owned tokens into a single webpage, and the like.

Various disclosed embodiments further allow for providing NFTs or other tokens representing unique digital assets without requiring transfers involving the NFTs to be recorded on a blockchain. In some embodiments, NFT nodes included in a database as described herein can be recorded in a centralized database regardless of whether such nodes are also stored on a blockchain. Storing the tokens in a centralized database also provides portability, thereby allowing token records to be transferred to a new blockchain as needed. In this regard, it is noted that recording tokens in both a centralized database and a decentralized data structure such as a blockchain allows for providing this portability for centralized records while providing an immutable ledger that can be utilized to validate accuracy of records stored in the centralized database.

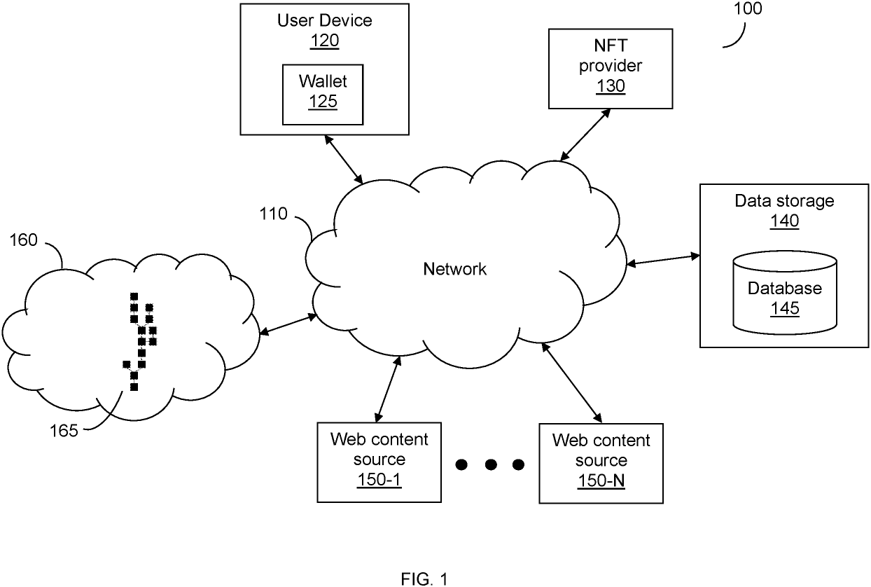

FIG. 1 shows an example network diagram 100 utilized to describe the various disclosed embodiments. In the example network diagram 100, a user device 120, a non-fungible token (NFT) provider 130, a data storage 140, a plurality of web content sources 150-1 through 150-N (hereinafter referred to individually as a database 140 and collectively as databases 140, merely for simplicity purposes), and a blockchain network 160 communicate via a network 110.

The network 110 may be, but is not limited to, a wireless, cellular or wired network, a local area network (LAN), a wide area network (WAN), a metro area network (MAN), the Internet, the worldwide web (WWW), similar networks, and any combinations thereof.

The user device (UD) 120 may be, but is not limited to, a personal computer, a laptop, a tablet computer, a smartphone, a wearable computing device, or any other device capable of receiving and displaying media content. The user device is equipped with one or more input/output (I/O) devices (not depicted in FIG. 1) which can display or otherwise project media content associated with webpages or portions of webpages owned by the user of the user device 120.

As depicted in FIG. 1, the user device 120 includes a wallet 125. In this implementation, the wallet 125 may be a program stored and executed on the user device 120. In other implementations, the wallet 125 may be a device (not depicted in FIG. 1) connected to the user device 120. In yet other embodiments, the wallet 125 may be stored on another system (not depicted in FIG. 1) such as a server of an NFT platform or another server owned by a provider of NFT services. The wallet 125 stores ownership data used to access the reality-altering media content of webpages represented in the database 145 such as, but not limited to, token ownership data, authentication credentials, and the like.

The NFT provider 130 is configured to at least encode webpages as well as to create databases (e.g., a database 145) including nodes and webpage code as described herein. The NFT provider 130 may be further configured to provide reality-altering content associated with webpages to owners of NFT nodes in the database 145 as described herein.

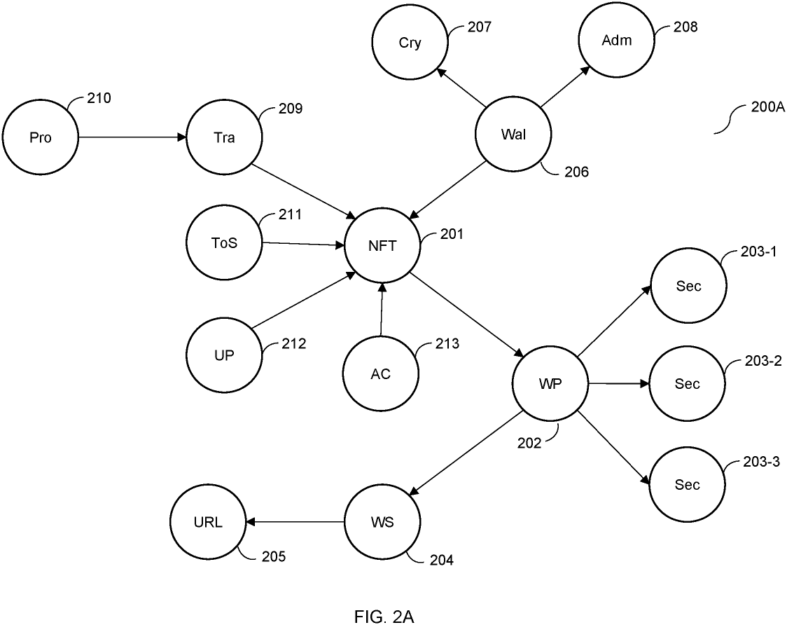

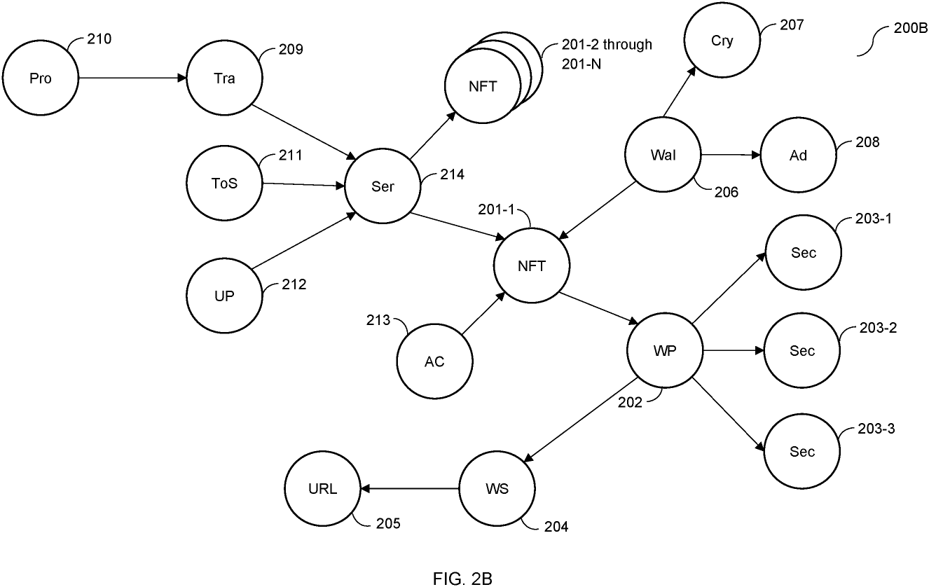

The data storage 140 stores a database 145 that is at least partially populated with code and nodes created by the NFT provider 130 as described herein. The database 145 stores nodes (not depicted in FIG. 1) connected to each other (e.g., via edges). The nodes at least include webpage nodes associated with respective webpages and NFT nodes associated with NFTs defined with respect to content of the webpages. In an embodiment, the database 145 may be realized as a graph (e.g., a hypergraph such as a multi-tenant temporal hypergraph). An example illustration of nodes in the database 145 realized as a graph is described further below with respect to FIG. 2.

The web content sources 150 store content of webpages including, but not limited to, media content, computer models used to generate media content (e.g., 3D models which can be used to render images or videos of items), software instructions for providing computer-mediated reality experiences, combinations thereof, and the like. According to various embodiments, such media content is reality-altering media content such as augmented reality (AR) content, virtual reality (VR), or mixed reality (MR) content. Accordingly, the media content includes virtual objects or other representations of items which can be overlaid on, projected on, used to replace, or otherwise used to modify original media content reflecting a real-world environment experienced by a user. Such content is encoded by the NFT provider 130 as described herein and stored in the database 145 in order to enable providing the appropriate content when an owner of an NFT (e.g., a user of the user device 120) requests to access the content associated with the NFTs they own.

The blockchain network 160 includes multiple computing nodes (not shown), each computing node storing a copy of a blockchain 165. In various embodiments, the database 145 or a copy of the database 145 may be stored on the blockchain 165, thereby enabling the benefits of such blockchain use discussed above. To this end, in some embodiments, the NFT provider 130 may be configured to upload transactions to the blockchain 165 as the database 145 is updated. The transactions uploaded to the blockchain 165 may include a full copy of the database 145 or one or more changes to the existing copy of the database 145.

It should be noted that the network diagram 100 is merely an example, and that other combinations of networked components may be equally utilized without departing from the scope of the disclosure. Further, it should be noted that all components illustrated in FIG. 1 are depicted as communicating via a single network 110 merely for simplicity, but that different networks or no networks may be used for different communications among the components without departing from the scope of the disclosure.

FIG. 2A is a non-limiting example visual depiction 200A of nodes in a database realized as a hypergraph.

The example visual depiction 200A includes various nodes connected to an NFT node 201. The NFT node 201 represents a tokenized version of a unique digital asset that is reality-altering media content included in a webpage or is otherwise represented by media content included in the webpage such that the webpage can be encoded into portions of code (e.g., code in hypertext markup language) for projecting the media content.

In some embodiments, the NFT node 201 may further include transaction data indicating historical transactions involving the NFT represented by the NFT node 201 (e.g., transactions which resulted in modification of the database involving changing connections between the NFT node 201 and wallet nodes or owning entity nodes), the initial creation of the NFT node 201, both, and the like. Consequently, the NFT node 201 may also include a complete history of ownership of the NFT. Storing such historical data allows the NFT node 201 to serve as a proof of authenticity or otherwise as a proof of ownership history for the NFT represented by the NFT node 201.

The NFT node 201 is connected to a webpage (WP) node 202 representing a corresponding webpage tokenized via the hypergraph. In various embodiments, the NFT node 201 includes one or more portions of code created by encoding the corresponding webpage represented by the webpage node 202 connected to the NFT node 201. Such portions of code may include instructions in formats such as, but not limited to, cascading style sheets (CSS), Javascript, hypertext markup language (HTML), combinations thereof, and the like. In other embodiments (not shown), such portions of code may be stored in code nodes (not shown) which are distinct from the NFT node 201 and are connected to the NFT node 201, the webpage node 202, or both. Such portions of code can be provided to an authorized device, thereby allowing such an authorized device to use the portions of code to generate a computer-mediated reality view including any applicable reality-altering media content.

In various embodiments, the code included among nodes of the graph include instructions for configuring a user device (e.g., the user device 120, FIG. 1) to access one or more sensors (such as, but not limited to, camera) of the user device and to cause projection of the reality-altering media content in combination with (e.g., as an overlay) or instead of real-world content reflected in sensor signals captured by those sensors, thereby generating the computer-mediated reality view and providing any associated content. Accordingly, the computer-mediated reality content, which may be encoded from a webpage and stored in a node such as the NFT node 201, may be effectively tokenized and assigned to a user who owns the NFT node 201.

In various further embodiments, the code may also include code for identifying a position and/or an orientation of the user device through which computer-mediated reality content is to be projected, as well as for determining which portions of computer-mediated reality content are to be projected via the user device based on the current location and/or orientation of the user device. To this end, such code may include instructions for accessing a global positioning system (GPS), gyroscope, or other location and/or orientation sensors of the user device. Accordingly, such code may be used to provide appropriate reality-altering content for a given location, orientation, or combination of location and orientation.

To this end, the data in the webpage may further include data defining particular locations, orientations, or combinations of locations and orientations, as well as indications of which content to project at those locations and/or orientations and how to project that content. As a non-limiting example, the reality-altering content may be AR models of various pieces of artwork, wherein visual representations of different pieces of artwork are projected depending on the geographical location of the user device. In that example, the projection of the AR content may further be altered depending on the orientation of the user device (e.g., a model may be rendered at a different orientation depending on the orientation of the user device).

In some implementations, the content to be provided may include unlocked or premium content that is location-specific. As a non-limiting example, the computer-mediated reality content may include visual media content showing a prize won by a user or a code that can be redeemed for such a prize, where the specific content shown depends on the location of the user device. This unlocked or premium content may be defined per user, for example, by defining location and corresponding unlocked or premium content in the associated with each user such that different users are assigned different locations and respective unlocked or premium content. The unlocked or premium content may be assigned randomly, based on a type of ticket (e.g., more expensive tickets may be assigned different premium content than less expensive tickets), based on additional payments made by users when purchasing the NFT (e.g., premium content may be purchased for an additional fee when buying an NFT), combinations thereof, and the like.

As a non-limiting example where each NFT represents a ticket for entry to a baseball game, each NFT is owned by a user who is assigned a respective seat in a baseball stadium, and the webpage for the NFT defines a location within the stadium (i.e., the location of a seat) as well as an image of a prize redemption code to be projected on the user device at the location. In a further non-limiting example, the webpage of each NFT used as a ticket for the baseball game is the same as other webpages of other NFTs but for defining different locations and having premium content such that different users are assigned different seats and awarded different premium content.

In some embodiments, the webpage node 202 may further be connected to multiple section nodes such as section (Sec) nodes 203-1 through 203-3. The section nodes 203-1 through 203-3 represent different sections of the webpage represented by the connected webpage node 202. By representing sections of webpages as distinct nodes, webpage tokenization may be realized in a more granular fashion, i.e., such that multiple tokens may be created for a single webpage and multiple owning entities may each effectively own a different portion of the same webpage. The portion of a webpage for a respective owning entity may be represented and rendered as a distinct webpage including the corresponding content owned by that entity.

The webpage node 202 may further be connected to a website (WS) node 204 representing the website including the webpage represented by the webpage node 202. The website node 204 may further be connected to other webpage nodes (not shown) representing various webpages of the website. Additionally, the website node 204 may be connected to a location node such as a uniform resource locator (URL) node 205 representing a URL associated with the webpage. In other embodiments (not shown), each webpage node may also be connected to a corresponding URL node indicating the location of the respective webpage on the Internet.

The NFT node 201 may further be connected to a node associated with an entity that owns the NFT of the NFT node 201 such as the wallet (Wal) node 206. The wallet node 206 represents and stores data indicating ownership of the NFT represented by the NFT node 201 such that the connection between the wallet node 206 and the NFT node 201 can be utilized to confirm ownership of the NFT by the owner of the wallet. The wallet node 206 may also optionally represent an NFT (e.g., the wallet 125, FIG. 1).

The wallet node 206, in turn, may be connected to one or more cryptocurrency (Cry) nodes 207, a wallet administrator (Adm) node 208, or both. The cryptocurrency nodes 207 may represent cryptocurrency owned by the owner of the wallet. Such cryptocurrency may be used to conduct transactions involving transfers of NFTs such as using the cryptocurrency to purchase an NFT to be transferred to the wallet or receiving cryptocurrency as payment for such an NFT. The wallet administrator node 208 may be associated with an administrator of the wallet (e.g., the owner of the wallet or a third party entity who has been granted the right to act on behalf of the wallet owner), and may store data indicating policies related to use of the wallet.

In some implementations (not shown), multiple wallet administrator nodes may be connected to any given wallet node, and each administrator represented by one of the wallet administrator nodes may own a fractional share of the wallet. Each wallet administrator node may further include data indicating a percentage of ownership of the wallet by the administrator associated with the wallet administrator node. This percentage of ownership may further be connected to an accounting system (not shown), which may represent balances in any currency.

The NFT node 201 may further be connected to one or more nodes representing policies to be applied in relation to creation, use, or access of NFT nodes such as, but not limited to, a transfer node 209, a terms of service (ToS) node 211, a usage policy (UP) node 212, or a combination thereof.

The transfer node 209 may act as a minting contract, i.e., a smart contract defining policies for creation of NFT nodes for webpages (i.e., minting of webpages as NFTs). To this end, the transfer node 209 may store code that, when executed, applies the rules of the policy to the creation of NFT nodes such as the NFT node 201. Such policies may include, but are not limited to, restrictions on the number of NFTs which can be created (i.e., the number of NFT nodes which can be created) for a given webpage or portion thereof. As a non-limiting example, such a policy may limit the creation of NFTs for a given webpage to 100 NFTs total.

In some implementations, the transfer node 209 may further be connected to a provider (Pro) node 210 representing a provider of the NFT. Such a provider may be, but is not limited to, a creator of the NFT, a company representing the creator of the NFT, and the like. In this regard, the provider node 210 may serve as evidence of the originator of the NFT node 201.

The terms of service node 211 includes code that, when executed, applies the rules of one or more policies defining terms of service for an NFT. Such policies may require, for example, that a user to whom the NFT is transferred (e.g., a user of a wallet represented by a wallet node to which the NFT node will be connected) agree to terms of service before being granted ownership of or access to the NFT.

The usage policy node 212 includes code that, when executed, applies the rules of one or more policies defining restrictions on use of an NFT, access to the NFT, both, and the like. Such restrictions may include, but are not limited to, requiring that NFTs not be shared for free, limiting the number of uses of a given NFT, and the like. In various embodiments, multiple usage policies (which may be represented by multiple usage policy nodes, not shown), may be applied to any given NFT or series of NFTs. The usage policies may be defined by a platform for the NFTs, a marketplace for the NFTs, a provider of an NFT, or a combination thereof, depending on the implementation.

In a further embodiment, the usage policy represented by the usage policy node 212 may require an access code before using or accessing the NFT of the connected NFT node 201 in order to prevent unauthorized access. To this end, the NFT node 201 may also be connected to an access code (AC) node 213 representing an access code required to use or access the NFT. As a non-limiting example, before web content of the webpage represented by the webpage node 202 is provided, a user of the wallet represented by the wallet node 206 or other user indicated by the wallet node 206 may be required to enter the access code indicated by the access code node 213.

FIG. 2B is a non-limiting example visual depiction 200B of nodes in a database including a token series node. As depicted in FIG. 2B, the nodes of the database further include an NFT series (Ser) node 214. The NFT series node 214 may define a series of related NFTs such as, but not limited to, music tracks of an album, art pieces in a collection, and the like.

The NFT series node 214 is connected to multiple NFT nodes including the NFT node 201-1 and other NFT nodes 201-2 through 201-N. As depicted in FIG. 2B, the series node 214 may be connected to any of the transfer node 209, the terms of service node 211, and the usage policy node 212, such that rules and policies defined in data of those nodes may be applied to all of the NFTs represented by the NFT nodes 201-1 through 201-N. Accordingly, using series nodes such as the NFT series node 214 allows for defining policies for groupings of NFTs rather than defining policies individually per NFT. As new NFTs are added to a series (for example, by connecting new NFT nodes to the NFT series node 214), the policies for the NFT series node 214 may be automatically linked to their respective NFT nodes via the connections in the database.

Further, in another implementation (not depicted in FIG. 2B), additional policy-related nodes (e.g., additional transfer nodes, terms of service nodes, and/or usage policy nodes) may be connected to any or all of the NFT nodes 201-1 through 201-N such that, in addition to any policies applicable to all NFTs in the series, each NFT may have its own policies applied.

It should be noted that FIGS. 2A and 2B depict various specific numbers of nodes, numbers of connections, types of nodes, and connections between different types of nodes for example purposes, but that the disclosed embodiments are not necessarily limited to the specific depiction of nodes and connections illustrated in FIG. 2. In particular, only one instance of many types of nodes are depicted in FIGS. 2A and 2B for simplicity purposes, but in various implementations multiple of each node may be included without departing from the scope of the disclosure. Further, the additional NFT nodes 201-2 through 201-N are depicted without connections to nodes other than the series node 214 merely for simplicity, and that, in various implementations, each of these NFTs 201-2 through 201-N may be connected to other nodes.

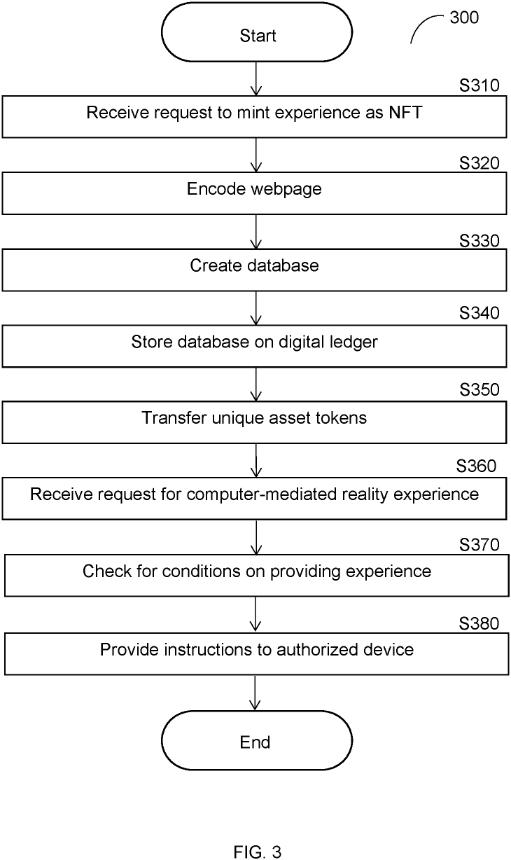

FIG. 3 is a flowchart 300 illustrating a method for providing computer-mediated reality content via webpage NFTs according to an embodiment. In an embodiment, the method is performed by the NFT provider 130.

At S310, a request to mint a computer-mediated reality experience as an NFT is received. The computer-mediated reality experience is realized as content and instructions included in a webpage. The request may include, but is not limited to, information needed to access the webpage (e.g., a uniform resource locator, authentication credentials, etc.). The request may further include various restrictions to be applied to the NFTs representing the webpage. Such restrictions may include, but are not limited to, terms of service, usage policies, access codes, combinations thereof, and the like. The minting process at least includes encoding all or a portion of the webpage as well as adding tokens for the webpage to a database as described further below.

The webpage is associated with one or more digital assets representing respective computer-mediated reality experiences and includes content used to provide the associated digital assets. As a non-limiting example where the digital asset is an AR experience in which a cartoon character is to be overlaid on a view of a user’s surrounding captured by a camera of the user’s device, the webpage associated with the digital asset may include visual media content showing the cartoon character as well as instructions for accessing a camera and a screen of the user’s device in order to overlay the cartoon character on the user’s screen.

At S320, the webpage is encoded into one or more portions of code. The portions of code include instructions that, when executed by a system (for example, at the user device 120, FIG. 1), causes the system to access sensors (e.g., a camera), project media content (e.g., by rendering images or other visual content, projecting sound for audio content, etc.), generate media content based on three-dimensional models, determine applicable content for a given location and orientation (i.e., content to be overlaid or otherwise provided at different locations and orientations), combinations thereof, and the like. Accordingly, such code can be stored in a database (specifically, in nodes of the database) such that the appropriate code can be provided (e.g., to a user device) when the owner of the NFT representing the respective portion(s) of code requests to access the computer-mediated reality experience, and execution of the code on a device of that owner allows for displaying or otherwise projecting media content to that owner as part of the computer-mediated reality experience.

Moreover, the encoded webpage may include multiple different media content items such that encoding the webpage may result in code for providing a multimedia experience using multiple distinct media content items. As a non-limiting example, an encoded webpage may include an audio file and an image file such that, when code of the webpage is executed on a user device, audio may be played while an image is displayed, thereby creating an experience with multiple distinct media content items. As a further example, the encoded webpage may have media content items including audio for a song, an image of album art, and text of song lyrics. These media content items can be bundled as a complete multimedia experience NFT such that, when the encoded webpage is executed, the album art and/or song lyrics may be displayed on a screen of a user device while the audio of the song is projected by a speaker of the user device.

In this regard, it is noted that existing NFT solutions typically tokenize individual media content items. For example, existing solutions may tokenize a music track and an image of a piece of art as two different NFTs. In addition to introducing new techniques for tokenizing individual media content items, the disclosed embodiments can be utilized to tokenize unique multimedia experiences featuring combinations of different media content items by including different media content items in a single webpage and tokenizing an encoded version of the webpage containing those different media content items. Moreover, tokenizing such multi-media content item webpages can allow for providing richer user experiences that better simulate the feeling of owning a tangible asset than existing NFT solutions.

At S330, a database is created based on the encoded webpage. Creating the database may include creating a new database or adding to an existing database.

The created database includes nodes, and the portions of code of the encoded webpage are distributed among at least some of the nodes of the database. In an embodiment, the database at least includes webpage nodes and NFT nodes. Each webpage node is associated with a respective webpage and indicates at least a portion of the respective webpage that is represented by the node. Each NFT node represents an NFT indicating ownership of a webpage or portion thereof. Each NFT node is at least connected to one or more webpage nodes. In a further embodiment, the portions of code are distributed among the webpage nodes.

The NFT nodes represent tokens which indicate ownership of one or more non-interchangeable digital assets with respect to a webpage. In various disclosed embodiments, such non-interchangeable digital assets include computer-mediated reality experiences such as AR or VR experiences, and such computer-mediated reality experiences include projecting media content to a user instead of or in addition to content captured via sensors of a user device. The unique assets represented by NFTs in the database may include media content, models (e.g., 3D models of items to be shown in the projected media content), or other content used for providing the computer-mediated reality experience, i.e., content used to modify content captured via sensors. The NFT nodes may further represent ownership of the underlying digital assets.

As a non-limiting example, a unique digital asset may be an AR experience involving a 3D model of a yellow mouse as well as instructions for overlaying video showing the yellow mouse on video content obtained via a camera, where the 3D model and the instructions are stored in a webpage. In such an example, an NFT node may represent ownership of the AR experience, the webpage including the 3D model and instructions used to provide the AR experience, or both. The webpage, including the model and instructions, is encoded into portions of code, and the portions of code are included in a webpage node representing the webpage. Accordingly, a user that owns the NFT (for example, a user of a wallet that stores ownership information of the NFT) can access the AR experience because the model and instructions for providing the AR experience can be retrieved from the database and provided to a device of that user.

Each NFT is a non-interchangeable token representing a digital item (i.e., a data item). These tokens are non-interchangeable at least in that any given NFT is not necessarily equivalent to any other token of the same type, in other words, at least some NFTs represent different underlying digital items as compared to at least some other NFTs.

It should be noted that some NFTs may be equivalent to each other without departing from the scope of the disclosed embodiments. As a non-limiting example, some NFTs may represent the same AR experience and others may represent different AR experiences, or each NFT may represent a distinct AR experience. As a non-limiting example, each NFT may represent a respective AR experience including overlaying an image of a respective piece of art on video of a real-world environment, and multiple NFTs may be minted for each piece of art in order to allow for distributing one NFT per piece of art to each user.

In some embodiments, multiple NFT nodes may be connected to a given webpage node, thereby establishing fractional ownership of the webpage, the underlying computer-mediated reality experience represented by the webpage, or both. Such fractional ownership may include equal shares of ownership or may be defined as percentage ownerships that may differ among the multiple owners. In some implementations, when an NFT having multiple owners with fractional ownership (i.e., an NFT represented by an NFT node among multiple NFT nodes connected to a given webpage node) is transferred in exchange for a different item or currency, ownership of the different item or currency may be distributed among the fractional owners according to their respective shares or percentage ownership.

The nodes of the database may further include other types of nodes such as, but not limited to, wallet nodes, website nodes, location identifier nodes (e.g., uniform resource locator or URL nodes), section nodes, transfer nodes, terms of service nodes, usage policy nodes, content nodes, combinations thereof, and the like. Various types of nodes are depicted in and described with respect to FIG. 2 as discussed above.

Different types of nodes in the database may effectively provide different information about a given NFT via their connections to an NFT node representing the NFT. Such information may include, but is not limited to, marketplaces on which the NFT is listed, similar NFTs that exist (e.g., different NFTs created based on the same underlying media content), authenticating details about the NFT (e.g., an originator or other source of the NFT or the underlying media content), combinations thereof, and the like. To this end, marketplaces or other sources of NFTs may be represented as nodes in the graph, and NFTs known to be similar may be connected to each other in the graph.

The information about the NFT may be used to provide an authentication token. In various embodiments, the authentication token may be realized as an interactable icon visible on a webpage associated with an NFT (e.g., the webpage containing the media content of the NFT). In some embodiments, when the icon is interacted with (e.g., by a user visiting the webpage clicking on the icon), the user may be navigated to a webpage (e.g., by opening a window containing the webpage) with a set of information about the NFT. The set of information of the NFT may be retrieved from the database with respect to a predetermined list of information to retrieve. In some embodiments, this view may further include a machine-readable or other label used to demonstrate authenticity such that the authentication token may demonstrate the trustworthiness of the NFT, thereby establishing the NFT as a ticket or other proof of permission. Consequently, this authentication token may further server as a factor used for authentication (e.g., a first factor of a two-factor authentication).

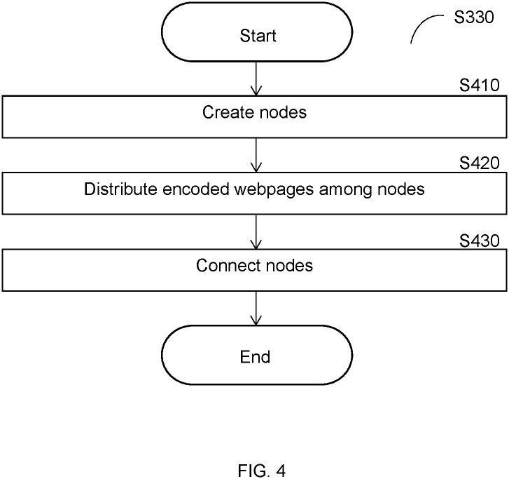

In an embodiment, the database may be created as discussed with respect to FIG. 4. FIG. 4 is a flowchart S330 illustrating a method for creating an NFT database according to an embodiment.

At S410, nodes of the database are created. In an embodiment, the nodes in the database at least include webpage nodes representing encoded webpages or portions thereof as well as NFT nodes representing NFTs indicating ownership of respective webpages or portions thereof. The encoded webpages, in turn, include software instructions for accessing sensors of a user device and for projecting reality-altering content (i.e., computer-mediated reality content) via the user device. In a further embodiment, the nodes of the database include nodes associated with entities who own the NFTs such as wallet nodes representing wallets owned by such entities or owning entity nodes representing the entities themselves. In yet a further embodiment, the nodes of the database may further include any of the other nodes described above with respect to FIGS. 2A and 2B. It should be noted that the database may include other nodes without departing from the scope of the disclosure.

In some embodiments, the nodes of the database may further store historical data of transactions in which NFTs are transferred. To this end, in a further embodiment, creating the nodes may further include storing initial transaction data in one or more of the nodes. As a non-limiting example, transaction data representing the initial creation of each NFT may be stored in the respective NFT node for each NFT when the NFT nodes are created. Alternatively, the initial transaction data may be null data representing that no transactions involving the NFT have occurred yet.

At S420, the portions of code of encoded webpages are distributed among the created nodes. In an embodiment, the portions of code may be distributed into webpage nodes of the respective webpages which were encoded into those portions of code. As a non-limiting example, a first webpage may be encoded into a first portion of code and a second webpage may be encoded into a second portion of code such that the first portion of code is distributed to a first webpage node representing the first webpage and the second portion of code is distributed to a second webpage node representing the second webpage.

At S430, the created nodes are connected. In an embodiment, the created nodes are connected at least such that each NFT node is connected to a respective webpage node representing the webpage provided as an NFT. In a further embodiment, the created nodes may be connected such that each NFT node is also connected to a wallet node or owning entity node associated with the entity who owns the NFT. In another embodiment, the created nodes may be connected such that each NFT node is further connected to nodes for enforcing restrictions on use or access of the respective NFT such as, but not limited to, transaction nodes, terms of service nodes, usage policy nodes 212, access code nodes 213, combinations thereof, and the like.

Returning to FIG. 3, at optional S340, the database is stored on a digital ledger. In an embodiment, S340 may include uploading the database to a decentralized digital ledger such as a blockchain. As noted above, storing the database on a blockchain allows for ensuring the accuracy of the data in the database by providing an immutable record against which the database can be compared when making transfers, and storing the database on a decentralized ledger in addition to a centralized ledger allows for portability, i.e., the database may be transferred to a new digital ledger relatively easily. As a non-limiting example, the database may be stored as a side chain on a blockchain.

At optional S350, one or more of the NFT nodes are transferred to a new owner. In an embodiment, S350 may occur when a request to transfer the NFT nodes is received from a current owner of the NFT nodes. The request may indicate to transfer the NFT nodes immediately or upon meeting one or more conditions. The request may be received from a wallet of the current owner.

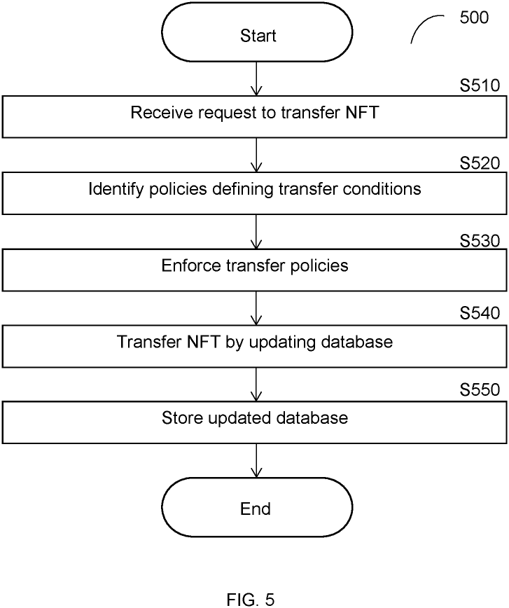

In an embodiment, transferring the NFTs may include reconnecting the respective NFT nodes corresponding to those NFTs. An example method for transferring NFTs via the database is described further below with respect to FIG. 5.

At S360, a request to provide a computer-mediated reality experience of a webpage is received. The request may indicate, for example, the NFT associated with the webpage (e.g., an NFT represented by an NFT node connected to a webpage node of the webpage in the database). The request may further include other information for accessing the content used to provide the computer-mediated reality experience such as, but not limited to, authentication credentials, authorized devices or accounts (i.e., devices or accounts that are authorized to access the content), both, and the like.

At optional S370, any conditions for providing the computer-mediated reality experience are identified. Such conditions may be defined in data of nodes associated with the NFT node such as, but not limited to, usage policy nodes or terms of service nodes. To this end, in an embodiment, S370 may include scanning the database for nodes connected (either directly or indirectly, i.e., through other nodes) to the NFT node and identifying conditions defined in those nodes. The conditions are applied when providing the requested computer-mediated reality experience and may be used to limit how the content and instructions of the computer-mediated reality experience are used or to deny access to the content and instructions entirely. The conditions may be set by different entities, for example, some conditions may be set by an operator of an NFT platform (e.g., an NFT platform), other conditions may be set by an originator of an NFT (e.g., an artist who created a work represented by an NFT), and yet other conditions may be set by an entity that provides the web-based content for tokenization (e.g., a record company, publisher webpage owner, etc.).

At S380, the instructions for providing the requested AR experience are provided to an authorized device, i.e., a device authorized to access the content and instructions by the owner of the respective NFTs associated with the webpage via the nodes of the database or a device used by a user of an authorized account indicated in the request. In an embodiment, S370 includes providing the respective portions of code through which the webpage is encoded to the authorized device. Because the portions of code of a webpage include instructions for projecting media content of the webpage, the authorized device can execute the portions of code, thereby causing the authorized device to project media content (e.g., by rendering visual content or projecting audio content via a speaker) via, for example but not limited to, overlay or replacement as part of a computer-mediated reality experience.

In an embodiment, the conditions identified at S370 are applied. It should be noted that, in some implementations, when a condition defining whether an AR experience can be shared is not met, the content and instructions of the AR experience may not be provided at S380. As a non-limiting example, when a usage policy node associated with an NFT node representing an NFT includes data defining a condition limiting the number of times the AR experience may be shared or viewed per day to 5 times per day and the AR experience has already been shared or viewed 5 times in 24 hours, access to the AR experience may be denied and the content and instructions are not provided to the otherwise authorized device. Optionally, a notification indicating the failure to meet one or more conditions may be sent to the authorized device or to a user device associated with the user who owns the NFT.

FIG. 5 is an example flowchart 500 illustrating a method for transferring NFT nodes of webpages using a database according to an embodiment. In an embodiment, the method may be performed by the NFT provider 130, FIG. 1.

At S510, a request to transfer an NFT is received. The request indicates information to be used for determining how to alter a database storing nodes in order to realize the transaction such as, but not limited to, an identifier of the NFT being transferred, an identifier of a first user from whom the NFT is being transferred, an identifier of a second user to whom the NFT is being transferred, identifiers of wallets of such users, identifiers of tokens of any of the foregoing, combinations thereof, and the like.

At optional S520, policies defining any potential transfer conditions on transferring the NFT are identified. Such conditions may be defined in data included in, for example, nodes of the database storing the NFT node representing the NFT. To this end, S520 may include scanning a database including an NFT node representing the NFT to be transferred for any nodes defining policies related to transferring the NFT such as, but not limited to, a transfer node or a terms of service node connected to such an NFT node or to an NFT series node of an NFT series the NFT belongs to. In an example implementation, the policies related to transferring the NFT may include a requirement that the user to which the NFT node is transferred must accept terms of service for the transferred NFT.

At optional S530, the policies defining the applicable transfer conditions identified at S520 are enforced. In the example implementation where the policies require the new owner to accept terms of service, S530 may include presenting the terms of service (e.g., by sending a notification for display on a user device of the new owner) and receiving a response indicating whether the user accepted the terms of service. In some implementations, if requirements of the policies related to transfers are not met, the NFT may not be transferred to the new owner.

At S540, the database is updated in order to transfer the NFT. In an embodiment, S540 includes modifying connections in the database including the NFT node representing the NFT such that the NFT is connected to a different node associated with the owning entity (e.g., a different wallet node or a different owning entity node).

More specifically, the transferred NFT may be initially connected to a node associated with the current owner (e.g., a wallet node associated with a wallet owned by the current owner of the NFT nodes or an owning entity node representing the current owner) and then reconnected to a node associated with the new owner instead. The database including the reconnected nodes is therefore updated.

In a further embodiment, updating the database may further include updating historical data stored in nodes of the database related to transactions. As a non-limiting example, historical data of transactions in which an NFT was transferred may be stored in an NFT node corresponding to the NFT such that updating the database may include adding a new entry to the historical data stored in the NFT node.

At optional S550, the updated database may be stored in a centralized data storage, a decentralized ledger such as a blockchain, or both.

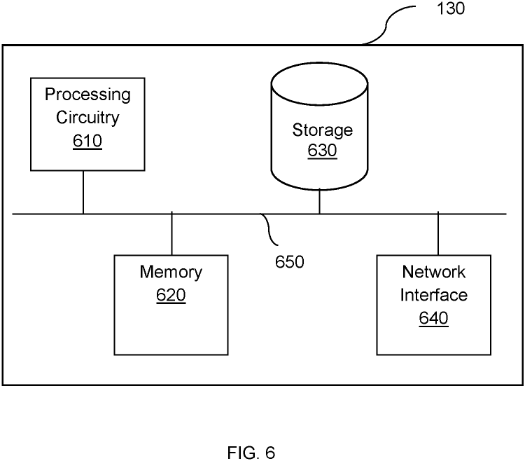

FIG. 6 is an example schematic diagram of a non-fungible token (NFT) provider 130 according to an embodiment. The NFT provider 130 includes a processing circuitry 610 coupled to a memory 620, a storage 630, and a network interface 640. In an embodiment, the components of the NFT provider 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the NFT provider 130 to communicate with, for example, the user device 120, the data storage 140, the web content sources 150, the blockchain network 160, combinations thereof, and the like.

It should be understood that the embodiments described herein are not limited to the specific architecture illustrated in FIG. 7, and other architectures may be equally used without departing from the scope of the disclosed embodiments.

It should be noted that various disclosed embodiments describe techniques for encoding computer-mediated reality experiences, but that various techniques disclosed herein can equally be applied to digital multimedia experiences regardless of whether those experiences involve computer-mediated reality experiences such as AR, VR, or mixed reality experiences using respective computer-mediated reality content.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for tokenizing digital multimedia experiences, comprising:
encoding a webpage into at least one portion of code, wherein the webpage is associated with at least one unique digital asset representing at least one digital multimedia experience, wherein each portion of code causes projection of computer-mediated reality media content corresponding to the at least one unique asset by a system when the portion of code is executed by the system, wherein the projected computer-mediated reality media content at least partially alters a perception of a reality reflected in sensor signals captured by at least one sensor of the system;
creating a database including a plurality of nodes, the plurality of nodes including a plurality of webpage nodes and a plurality of non-fungible token (NFT) nodes, wherein the encoded at least one portion of code of the webpage is stored among a portion of the plurality of nodes, wherein a first webpage node of the plurality of webpage nodes is associated with the webpage, wherein at least one first NFT node of the plurality of NFT nodes is connected to the first webpage node, wherein each of the at least one first NFT node corresponds to one of the at least one unique digital asset; and
providing the at least one portion of code to a device authorized by an owner of the at least one first NFT node.

2. The method of claim 1, wherein the first webpage node includes the encoded at least one portion of code of the webpage.

3. The method of claim 1, wherein the at least one portion of code includes instructions for projecting media content and instructions for accessing the at least one sensor of the system.

4. The method of claim 3, wherein the webpage further includes data of at least one three-dimensional model, wherein the at least one portion of code further includes instructions for generating media content to be projected based on the at least one three-dimensional model.

5. The method of claim 1, wherein the webpage further includes data defining at least one real-world location as well as rules for projecting media content at each of the at least one real-world location.

6. The method of claim 5, wherein the at least one portion of code further includes instructions for determining a current location of the system based on sensor signals captured by the at least one sensor of the system.

7. The method of claim 1, wherein the webpage further includes rules for projecting media content based on a current orientation of the system.

8. The method of claim 1, further comprising:
storing the database on a blockchain.

9. The method of claim 1, wherein each digital multimedia experience is any of: an augmented reality experience, a virtual reality experience, and a mixed reality experience.

10. A non-transitory computer readable medium having stored thereon instructions for causing a processing circuitry to execute a process, the process comprising:
encoding a webpage into at least one portion of code, wherein the webpage is associated with at least one unique digital asset representing at least one digital multimedia experience, wherein each portion of code causes projection of computer-mediated reality media content corresponding to the at least one unique asset by a system when the portion of code is executed by the system, wherein the projected computer-mediated reality media content at least partially alters a perception of a reality reflected in sensor signals captured by at least one sensor of the system;
creating a database including a plurality of nodes, the plurality of nodes including a plurality of webpage nodes and a plurality of non-fungible token (NFT) nodes, wherein the encoded at least one portion of code of the webpage is stored among a portion of the plurality of nodes, wherein a first webpage node of the plurality of webpage nodes is associated with the webpage, wherein at least one first NFT node of the plurality of NFT nodes is connected to the first webpage node, wherein each of the at least one first NFT node corresponds to one of the at least one unique digital asset; and
providing the at least one portion of code to a device authorized by an owner of the at least one first NFT node.

11. A system for tokenizing digital multimedia experiences, comprising:
a processing circuitry; and
a memory, the memory containing instructions that, when executed by the processing circuitry, configure the system to:
encode a webpage into at least one portion of code, wherein the webpage is associated with at least one unique digital asset representing at least one digital multimedia experience (DME), wherein each portion of code causes projection of computer-mediated reality media content corresponding to the at least one unique asset by a system when the portion of code is executed by the system, wherein the projected computer-mediated reality media content at least partially alters a perception of a reality reflected in sensor signals captured by at least one sensor of the system;
create a database including a plurality of nodes, the plurality of nodes including a plurality of webpage nodes and a plurality of non-fungible token (NFT) nodes, wherein the encoded at least one portion of code of the webpage is stored among a portion of the plurality of nodes, wherein a first webpage node of the plurality of webpage nodes is associated with the webpage, wherein at least one first NFT node of the plurality of NFT nodes is connected to the first webpage node, wherein each of the at least one first NFT node corresponds to one of the at least one unique digital asset; and
provide the at least one portion of code to a device authorized by an owner of the at least one first NFT node.

12. The system of claim 11, wherein the first webpage node includes the encoded at least one portion of code of the webpage.

13. The system of claim 11, wherein the at least one portion of code includes instructions for projecting media content and instructions for accessing the at least one sensor of the system.

14. The system of claim 13, wherein the webpage further includes data of at least one three-dimensional model, wherein the at least one portion of code further includes instructions for generating media content to be projected based on the at least one three-dimensional model.

15. The system of claim 1, wherein the webpage further includes data defining at least one real-world location as well as rules for projecting media content at each of the at least one real-world location.

16. The system of claim 15, wherein the at least one portion of code further includes instructions for determining a current location of the system based on sensor signals captured by the at least one sensor of the system.

17. The system of claim 11, wherein the webpage further includes rules for projecting media content based on a current orientation of the system.

18. The system of claim 11, wherein the system is further configured to:
store the database on a blockchain.

19. The system of claim 11, wherein each digital multimedia experience is any of: an augmented reality experience, a virtual reality experience, and a mixed reality experience.
